(19) United States
(12) Patent Application Publication
(10) Pub. No.: US 2007/0253308 A1
(43) Pub. Date: Nov. 1, 2007

(54) Device Comprising a Feedback Control Loop for a Signal of an Optical Pickup

(75) Inventor: Jeannet Van Rens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,529

(22) PCT Filed: Sep. 22, 2005
(86) PCT No.: PCT/IB05/53125

§ 371 Date: Apr. 3, 2007

(30) Foreign Application Priority Data
Oct. 5, 2004 (EP) 04104870.3

(51) Int. Cl. G11B 7/00

(52) U.S. Cl. 369/106

(57) ABSTRACT

A device comprises a means (3) for generating a modulated signal (4) and a feedback control loop. The feedback control loop comprises a sensor (5) for providing a sensor signal (6) dependent on the generated signal (4), a sampler (7) for sampling the sensor signal (6), a measurer (61) for measuring the lapsed time (tₗₐₚₛₑ) that has lapsed since a previous sampling, and a comparator (62) for comparing said lapsed time (tₗₐₚₛₑ) to a reference time period (52). The feedback loop filter is made inoperative, if said lapsed time exceeds the reference time period, until such time as a next sampling is performed.

The invention relates to a device comprising means for generating a signal and a feedback control loop, the feedback control loop comprising a sensor for providing a sensor signal dependent on the generated signal. The invention also relates to a method for feedback controlling means for generating a signal using a feedback signal generated by a sensor.

Many devices provide for a signal of which a characteristic such as the power is to be controlled.

A known method of controlling a characteristic of the signal is to use a control loop, comprising a sensor for a signal that depends on the generated signal. The feedback signal of the sensor is then compared to a reference signal to provide an error signal. This error signal is used via a feedback loop to control the generation of the signal. Stabilization of for instance power of a laser in an optical pick-up device is thereby made possible.

Such a feedback loop and method for feedback controlling a power signal has for instance been described in U.S. Pat. No. 6,061,317 in which the output of a monitoring photodiode is fed into a automatic power control APC for controlling the emissive power of a laser of an optical pick up device. In this device the signal generating device is the laser and the feedback control loop comprises the monitoring photodiode and the APC.

Although such feedback loops provide important advantages, the inventors have realized that, in circumstances where feedback signals are occasionally sampled, as reliable/stable signals are available only during these moments, less than optimal results may occur.

In devices and feedback controlling methods where the feedback signal is only occasionally sampled there is a risk that the feedback control loop becomes unstable, causing a run-off of the generated signal, in effect accomplishing the opposite of what the control loop and feedback control method are meant to accomplish.

The present invention aims to provide a device and method in which the above stated problem is reduced.

To this end the device comprises a modulator for modulation the generated signal, a sampler for sampling the sensor signal, a measurer for measuring the lapsed time that has lapsed since a previous sampling, a comparator for comparing said lapsed time to a reference time period, and for making inoperative the feedback loop filter, if said lapsed time exceeds the reference time period, until such time as a next sampling is performed.

The method in accordance with the invention comprises the steps of:

modulating the generated signal,

sampling the sensor signal,

measuring the lapsed time that has lapsed since a previous sampling,

comparing said lapsed time to a reference time period, and for turning off the feedback loop filter, if said lapsed time exceeds the reference time period, until such time as a next sampling is performed.

The invention is based on the following insights:

In many control loops, a decent feedback signal is not available directly but only in a form where it is modulated with a second signal F_{MON}. In such systems sampling of the sensor signal often is more attractive than time continuous multiplication. Sampling only requires knowledge about the actual modulation on the sampling moments, continuous-time multiplication requires “time-continuous-knowledge” on the modulation. However, not all modulated signals are suitable for sampling. This may (as will be exemplified below) result in large delay times between sampling. The delay is most severe in case the modulation signal contains rather low frequencies, like in a system where the modulation is more or less random, e.g. data based. The delay manifests itself as an extra phase delay in the feedback loop and may make the feedback loop instable. This happens in particular when the phase delay exceeds 45° (in case of a first order system and even earlier in case of a higher order system) and especially if the phase delay reaches even higher values.

The risk of instability of the feedback loop can be reduced by choosing the bandwidth of the loop sufficiently low, such that the maximum delay in the feedback does not give too much phase shift (e.g. less than 45 degrees), or in other words increasing the time constant of the feedback loop. Disadvantage of this solution is however that the time constant of the feedback loop is increased, which decreases the ability to control the signal, since the feedback loop cannot or least not effectively control fluctuations in the generated signal on a time scale smaller than the time constant of the feedback loop.

The device in accordance with the invention overcomes this problem.

The device comprises a means for measuring the time that has lapsed, since the last feedback sample has been taken. This lapsed time is compared with a threshold value. The method in accordance with the invention comprises the corresponding method steps.

As long as the lapsed time is below the threshold, the feedback control loop remains closed and operates normally. If the lapsed time raises above the threshold, which means that the last “refreshment” occurred longer ago than the time indicated by the threshold, the loop filter is turned off until a new sample is available. Typically, the effective “threshold time” is equal to n times the time constant (τ) of the feedback control loop, where n lies between 0.4 and 1.2, (n=0.79 provides for instance a 45 degree phase delay in a first order system) preferably between 0.6 and 0.9. Turning off the loop can be done by zeroing the error signal of the loop filter.

The advantage is that on the one hand, a loop filter with a relatively high band with may be used, while on the other hand too much phase shift is avoided.

Preferably the reference time period is, in operation, such that the feedback loop filter is on average made in operative less than 10%, preferably less than 2%.

The reference time period is also below indicated by ‘threshold value’, i.e. the value which forms a threshold between two modes of operation of the device. Reducing the threshold value will reduce the risk of instability but will increase the number instances at which the loop filter is turned off and increase the ‘turn-off time’. A trade-off between ‘down-time of the loop filter’ and bandwidth of the loop filter can be made.

The invention in its various embodiments allows a loop with a high bandwidth, which, in first order, does not depend on the exact number of feedback samples. Only occasionally, the bandwidth drops for a short period.

Advantageously the device comprises means for setting the threshold value, which threshold value may be linked to the loop bandwidth. The corresponding preferred method comprises corresponding method steps.

These and further aspects of the invention will be explained in greater detail by way of example and with reference to the accompanying drawings, in which

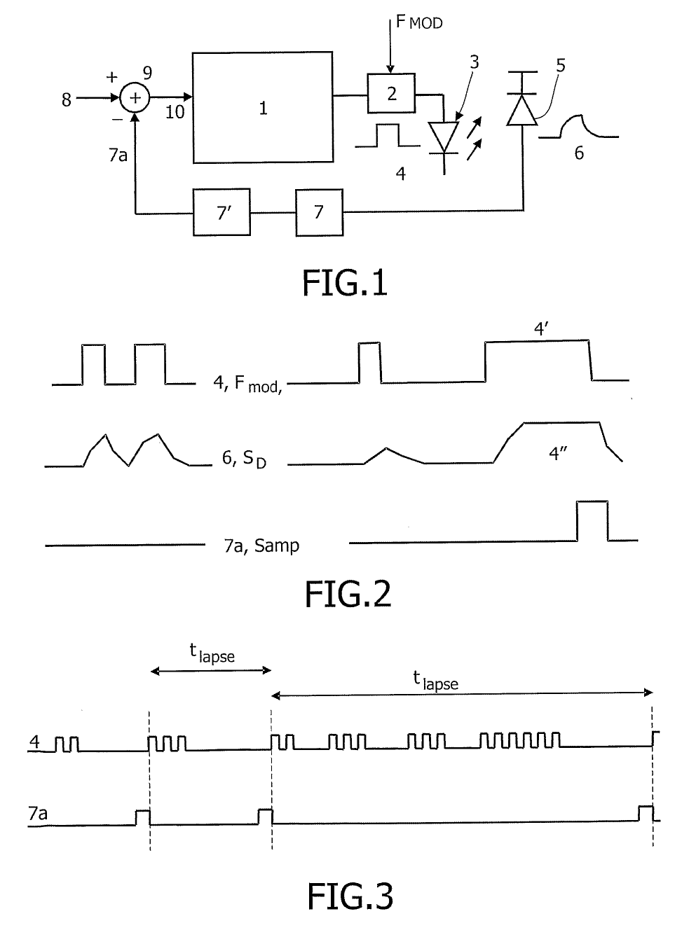

FIG. 1. illustrates schematically a laser control loop of an optical pick-up system.

FIG. 2 illustrates a modulation signal as send by means for generating a signal, the sensor signal, and the sampled signal.

FIG. 3 illustrates a modulated signal and a sample signal illustrating the lapse time.

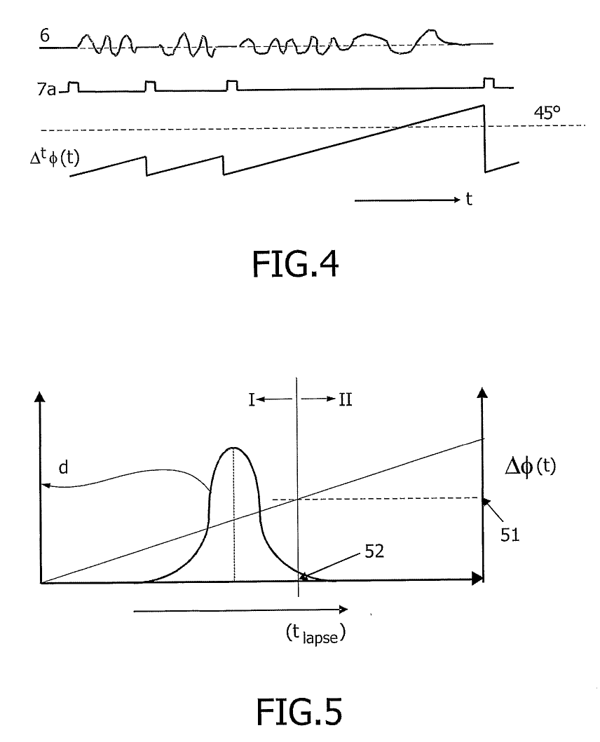

FIG. 4 illustrates a sensor signal and a sample signal, as well as the phase difference caused by delay times between samplings.

FIG. 5 schematically illustrates the distribution of distance between sampling (in time) and a relation between times between samples and phase delay.

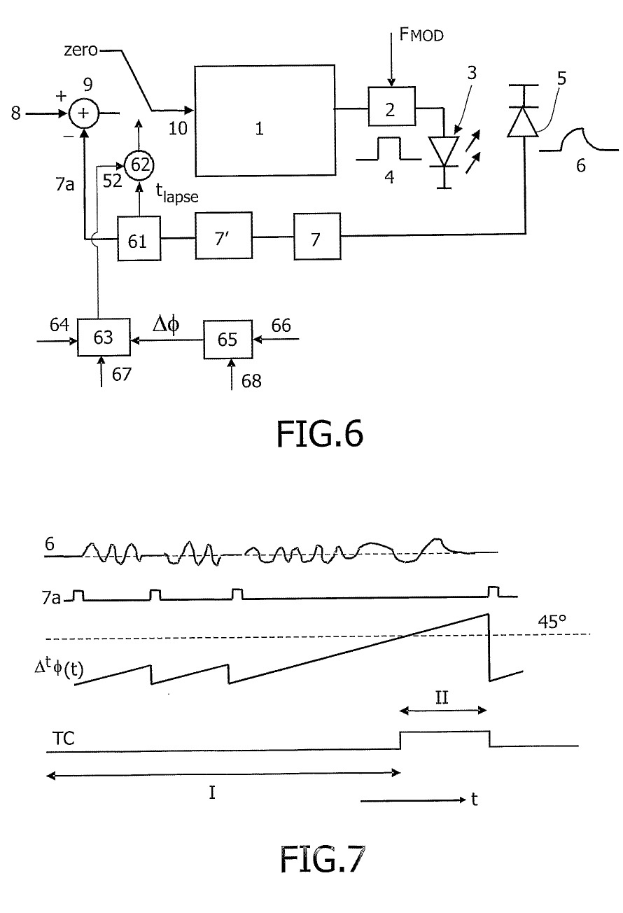

FIG. 6 schematically illustrates a device in accordance with the invention.

FIG. 7 illustrates various signals generated by or in a device or method in accordance with the invention.

The Figs. are not drawn to scale. Generally, identical components are denoted by the same reference numerals in the figs.

FIG. 1 illustrates an exemplary embodiment of a device in accordance with the invention, a laser control loop which is a part of an optical pick-up system such as for instance used in DVD and other data storage device such as an optical or magneto-optical disk device to record and/or reproduce data to and from a disk-type data storage medium.

A signal is generated by a laser driving circuit 1, the signal is modulated with a modulation F_{mod} at modulator 2, and sent to a laser 3 producing a modulated signal 4. Sensor 5, in this example for instance a photodiode, generates in dependence on the signal 4 a sensor signal 6. Due to the finite speed of the sensor 5 the sensor signal 6 is dependent on, but not necessarily equal to modulated signal 4. The light falling on the sensor 5 may be reflected by a disk or in any other way reflected or directly impinging on sensor 5.

In this system the sensor signal 6 is not available directly but only in a form where it is modulated with modulation F_{mod}. In such systems sampling of the sensor signal 6 often is more attractive than time continuous multiplication. Sampling only requires knowledge about the actual modulation on the sampling moments, continuous-time multiplication requires “time-continuous-knowledge” on the modulation. Sampling is performed in sampler 7, providing a sampled signal 7a. The system may comprise a hold circuit 7′ to hold the sample value. This signal 7a is compared in comparator 9 to a reference signal 8 providing an error signal 10, which is an input to laser driving system 1 to stabilize the laser power.

FIG. 2 illustrates the modulated signal 4, modulated with F_{mod}, the sensor signal 6, in FIG. 2 also denoted by S_{D}, i.e. the sensor signal. The sensor signal 6, which is dependent on the modulated signal 4 is also modulated with F_{mod}. However, not all of the modulated sensor signals are suitable for sampling. The sensor has its owns time constants, leading to a situation that fast modulated signals do not lead to a reliable sensor signal. Consequently only at particular times, i.e. when particular signals 4 are present the sensor signal can be sampled. This may result in large delay times between sampling. In FIG. 2 it is illustrated that only when the relatively long (in time) signal 4′ is emitted and sufficiently stabilized sensor signal 4″ is provided, and it is during this sensor signal 4″ that the sample is taken. The delay is most severe in case the modulation signal contains rather low frequencies, like in a system where the modulation is more or less random, e.g. data based. FIG. 3 illustrates this effect. Only after relatively long lived signal 4 sampling of signal 7a can be performed. Lapse times tₗₐₚₛₑ occur between the taking of samples.

The delay manifest itself as an extra phase delay Δφ (t) in the feedback loop and may make the feedback loop instable. This happens in particular when the phase delay exceeds 45° (in a first order system) and especially if the phase delay reaches even higher values. FIG. 4 illustrates this effect. The raw sensor signal 6 provides sampled signals 7a. However, these sampled signals are provided with lapse times, during such lapse times a extra phase delay Δφ (t) in the feedback loop occurs. When the phase delay becomes larger than a value, such as 45°, the feedback loop may become instable. During the last shown lapse phase delay occurring during the lapse time exceeds 45°.

Stability of such a feedback loop can be achieved by choosing the bandwidth of the loop sufficiently low, such that the maximum delay, i.e. the maximum lapse time in the feedback branch does not give too much phase shift (e.g. less than 45 degrees). Disadvantage of this solution is that it results in a, sometimes very, slow control loop, at least in a slower loop. There is a tendency for ever greater speed of reading and writing, which requires ever faster feedback loops, while the amount of data patterns that are suited to be sampled do decrease at higher speeds.

When the modulation is more or less random, the lapse times occur with a certain distribution. FIG. 5 illustrates the distribution d of lapse times as a function of the lapse time tₗₐₚₛₑ, showing an example of a probability distribution d of the distance in time between two adjacent sampling, wherein a kind of normal distribution has been assumed. The extra phase delay Δφ(t) is also dependent on the lapse time tₗₐₚₛₑ. The invention is based on the insight that it is advantageous to turn off the feedback loop when the lapse time exceeds a threshold time. In FIG. 5 this is illustrated by two regions I and II. In the first region I the feedback loop is operative, in the second region it is non-operative. The cut-off point between the two regions is determined by a threshold value 52. This may be a fixed threshold lapse time 52 or it may be a selected threshold value. Alternatively the threshold lapse time may be derived from a measured or estimated relation between phase delay Δφ(t) and the lapse time. In the later case a fixed phase delay, set or calculated phase delay is used and the threshold time 52 is derived from the phase delay threshold value.

FIG. 6 further illustrates an example of the invention. Means 61 for establishing the lapse time has as an output the instantaneous lapse time. A simple clock and timer may be used. The lapse time is in comparator 62 compared to a threshold value 52. This threshold value may be a fixed value, or, as schematically illustrated in FIG. 6, may be the output of a lapse time threshold determinator 63. This determinator 63 may have as an output a set value 64 for the threshold value 52, or an input for a threshold value for the phase delay Δφ. The value for the phase delay Δφ may be the output of a threshold phase delay setting determinator 65, which in its turn may have an input for a set value 66. The determinators 63 and 65 may have input for other parameters such as temperature and data transmission rates, which may influence the determination of the threshold value 52 directly or indirectly. Dependent on the outcome of the comparison made by comparator 62, the feedback loop is either operative if the lapse time is less than threshold value 52 or inoperative if the lapse time is more than the threshold value. When the feedback loop is inoperative, switch TC is closed and the error signal is zeroed. Within the framework of the invention, the transition from operative to a non-operative state need not be abrupt, and intermediate stages may be present, wherein the error signal is between a first threshold value 52′ and a second threshold value 52″ reduced to half its value before being sent to the laser drive circuit, and zeroed above the second threshold value 52″.

FIG. 7 illustrates the different signals wherein in comparison to FIG. 4 the signal on switch TC is added. When Δφ raises above a threshold (or when tₗₐₚₛₑ raises above a threshold value) the switch TC is closed, making the feedback loop inoperative.

The invention is most suitable when the feedback loop is arranged to control two different levels. During writing of a DVD+R disc, the laser power feedback control loop must control two power levels; the “bias” power, which is a low power level that does not cause any writing effect but allows some reading from the disc, and an accurate “write” power level that causes the actual pits. The information for both loops must be extracted from one modulated feedback signal 6. A same kind of story is true when writing DVD+RW discs. Basically, the feedback signal 6 has the form:

FS=feedback=bias_power+delta_power*data_pattern

with: data_pattern=pattern (writing strategy) of the written data

delta_power=writing power-bias power

The most accurate way to control both power levels is to sample the feedback signal 6 on two different places, a place that produces bias level and another place that produces write power.

Problem is that due to the limited bandwidth of the diode and pertaining buffer for generating the feedback signal, i.e. limitations in the sensor, the settling behavior might be insufficient to allow accurate sampling. This especially is the case for sampling the write power level in case a pulsed writing strategy is used.

It still is possible to sample the bias level on the last part of the longer run lengths, at least for the lower speeds. At higher writing speeds (N>4x, where N stands for the reading/writing speed in standardized units), only the very long effects e.g. only the I-14s can be sampled, because only for those the signal 6 is sufficiently settled to allow accurate sampling. I-n stands for a data with a certain length, where the longer n is the longer the data. Long effects occur less often than short effects. (Exception here is the I-14, which occurs more often than the I-11 due to the fact that I-14 is used as the frame-sync pulse.) Besides that, the amount of effects of a specific length that really does occur is distributed (I-14 excluded). Although the I-14 occurs exactly ones in 1488 efm-clock cycles, it can be both a high level as well as a low level. Therefore, the occurrence of a “low” I14 (long bias-level) is also not guaranteed. Thus the situation as schematically indicated in FIG. 5 occurs, i.e. the lapse time between the taking of samples is some kind of normal distribution. The distance between two I-14 effects with the same polarity is distributed according to a Poisson distribution. The probability density function of a the distance between two adjacent samples is given by the formula p(N)=X^{N}, with N=[1, ∞) in N*1488 efm-clock cycles and X<0.5.

So if we only sample I-14 low and the programmed threshold value is equal to 1488*6 efm-clock cycles (suited for a loop bandwidth of about 0.5*NDVD kHz.) and X=0.45, the loop will be closed and have a fixed bandwidth during 99.2% of the frames. A threshold value of 1488*3 efm-clocks allows a bandwidth of NDVD kHz. but then the loop will be switched off during 9% of all frames. Thus there is a trade-off between the ‘down-time’ and the bandwidth. Preferably the reference time period is, in operation, such that the feedback loop filter is on average made in operative less than 10%, preferably less than 2%. Even in case the loop is interrupted only 1% of the time, its function still is valuable, as it will prevent instability of the loop (overshoot of power) during this one percent of time. Nevertheless it also means that apparently the chosen bandwidth of the control loop was low, and it may be more advantageous to choose a higher bandwidth, if desired.

Advantageously the device comprises means for setting the threshold value, which threshold value may be linked to the loop bandwidth. The corresponding preferred method comprises corresponding method steps.

Sampling can be done on any signal level (high, medium or low) as long as the expected signal level is known. Practically, sampling on a low signal level (bias level) is often done during writing of a write-once disc, while for rewritable discs, the sampling is performed on an intermediate signal level (erase).

In short, the invention may be described as follows:

A device comprises means (3) for generating a modulated signal (4) and a feedback control loop. The feedback control loop comprises a sensor (5) for providing a sensor signal (6) dependent on the generated signal (4), a sampler (7) for sampling the sensor signal (6), a measurer (61) for measuring the lapsed time (tₗₐₚₛₑ) that has lapsed since a previous sampling, and a comparator (62) for comparing said lapsed time (tₗₐₚₛₑ) to a reference time period (52). The feedback loop filter is made inoperative, if said lapsed time exceeds the reference time period, until such time as a next sampling is performed.

Within the concept of the invention a ‘comparator’, “means for comparing’, means for generating’, ‘generator’, ‘sensor’ etc. is to be broadly understood and to comprise e.g. any piece of hard-ware (such a comparator, generator, sensor), any circuit or sub-circuit designed for making an comparison, generating a signal etc. as described as well as any piece of soft-ware (computer program or sub program or set of computer programs, or program code(s)) designed or programmed to perform such tasks in accordance with the invention as a whole or a feature of the invention, whether in the form of a method or a system, as well as any combination of pieces of hardware and software acting as such, alone or in combination, without being restricted to the given exemplary embodiments.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. Device comprising a means (3) for generating a signal (4) and a feedback control loop, the feedback control loop comprising a sensor (5) for providing a sensor signal (6) dependent on the generated signal (4), wherein the device comprises a modulator (2) for modulating the generated signal (4), a sampler (7) for sampling the sensor signal (6), a measurer (61) for measuring the lapsed time (tₗₐₚₛₑ) that has lapsed since a previous sampling, a comparator (62) for comparing said lapsed time (tₗₐₚₛₑ) to a reference time period (52), and for making inoperative the feedback loop filter, if said lapsed time exceeds the reference time period, until such time as a next sampling is performed.

2. Device as claimed in claim 1, wherein, the reference time period (52) is, in operation, such that the feedback loop filter is on average made inoperative less than 10%, preferably less than 2%.

3. Device as claimed in claim 1, wherein the device comprises means (63) for setting the reference time period (52).

4. Device as claimed in claim 1, wherein the device is a laser control loop of an optical pickup device, the generated signal is a modulated light signal and the sensor is a light sensor.

5. Method for feedback controlling means for generating a signal using a feedback signal generated by a sensor, wherein the method comprises the steps of modulating the generated signal, sampling the sensor signal, measuring the lapsed time that has lapsed since a previous sampling, comparing said lapsed time to a reference time period, and for turning off the feedback loop filter, if said lapsed time exceeds the reference time period, until such time as a next sampling is performed.

6. Method as claimed in claim 5, wherein the reference time period is set.

7. Method as claimed in claim 5, wherein a modulated light signal is generated and a sensor signal is generated by measuring a light signal dependent on the generated light signal.

8. Apparatus for reading and/or writing information from/to an information carrier, comprising a device as claimed in claim 1.
